(19) United States
(12) Patent Application Publication
(10) Pub. No.: US 2008/0192123 A1
(43) Pub. Date: Aug. 14, 2008

(54) Camera Mountings Liquid Formulation

(76) Inventor: Richard Arthur Lindsay, Suffolk (GB)

Correspondence Address: MCGUIREWOODS, LLP, 1750 TYSONS BLVD, SUITE 1800, MCLEAN, VA, 22102, US

(21) Appl. No.: 11/913,668

(22) PCT Filed: May 5, 2006
(86) PCT No.: PCT/GB2006/001641

§ 371 Date: Nov. 5, 2007

(30) Foreign Application Priority Data
May 5, 2005 (GB) 0509232.5

(51) Int. Cl. H04N 5/228

(52) U.S. Cl. 348/208.2; 348/208.7; 348/E05.031

(57) ABSTRACT

A TV/video camera (12) converts optical images into electronic image data. A mounting (10) for the camera has moving and non-moving components to provide movement of the camera in pan and tilt axes and damping means for damping movement in each axis. To remove unwanted movement transmitted to the mounting encoders (16,17) measure movement between the moving and non-moving parts of the mounting in each axis to indicate intended camera movement, and an electronic gyroscope (18) measures actual movement of the camera/mounting in the or each axis. A microprocessor (20) is provided separate from the camera to receive said electronic image data from the camera and input from the encoders and gyroscope to determine the unwanted movement of a camera from the intended and actual movement signals and to modify the image data to remove the unwanted camera movement from the data.

This invention relates to camera mountings and in particular to TV or video camera mountings on which a camera is supported for pan and tilt movement.

Modern pan and tilt mountings incorporate refined bearing arrangements which permit this pan and tilt movement of the camera and refined damping systems to enable the camera operator to move the camera as smoothly as possible. Any slight jerkiness in the movement is inevitably apparent in the image which is subsequently viewed usually by a television.

Whilst a skilled camera man can exercise great caution in moving the camera to avoid inputting any vibration or jerkiness into its movement, it is inevitable that other forces can act on the camera causing unwanted movements. For example vibration or movement through the ground or base on which the camera is supported reaches the camera through the mounting and may affect the image recorded by the camera. Other external forces such as wind force exerted on the camera can also cause unwanted camera movement.

Our International patent publication number WO 00/39498 addresses these problems and discloses a mounting for an optical apparatus having an optical axis, the mounting having non-moving and moving components including a base and support for the optical apparatus which provides movement about one or more orthogonal axes (e.g. in pan and tilt) and having damping means between the moving and non-moving components for the or each axis. Means are provided for measuring the movement between the moving and non-moving parts in the or each axis to indicate the intended movement of the support as imparted by the camera operator. In addition means are provided for measuring the actual movement of the support in the or each axis by a gyroscope or equivalent device and the difference between the actual and the intended movements is the determined and used to apply correction to the support/apparatus to counter the unintended movements. The mounting plate for the camera is a two part plate with motorised devices between the parts for adjusting the parts with respect to one another in the pan and tilt axes of the camera and the unwanted movement of the camera determined as indicated above is used to operate a control system for the motorised device to adjust the mounting tapered for the camera to counter the unwanted movement. As an alternative to adjusting a mounting plate, the correction signal could be applied to the camera optics or to the image recorded by the camera rather than the mechanical movement of the camera itself.

This invention provides a camera having means to receive an optical image and to convert the optical image into an electronic image data, a mounting for the camera comprising moving and non-moving components to provide for movement of the camera in one or more-axes clamping means for damping movement in the or each axis of movement of the mounting for removing unwanted movement transmitters to the mounting, first means being provided to measure movement between the moving and non-moving parts of the mounting in the or each axis to indicate intended camera movement, second means being provided for measuring actual movement of the camera/mounting in the or each axis, and an image processing device being provided separate from the camera to receive said electronic image data and input from the first and second means for measuring movement of the camera, the processing device determining the unwanted movement of a camera from the intended and actual movement signals and modifying the image data to remove the unwanted camera movement from the data.

In one arrangement in accordance with the invention the mounting may have parts relatively movable about a horizontal tilt axis for the camera and parts which are relatively movable about a pan axis extending transversely to the tilt axis and rotary damping means acting between the relatively movable parts in each axis and said first means provide for determining movements about the mounting part in both pan and tilt axes and providing corresponding signals to the image processing device and the second means provide signals corresponding to actual movement of the camera/mounting in said pan and tilt axes to the image processing device.

In one particular arrangement encoders may be provided between the relatively moving parts of the mounting in the or each axis providing a signal to the image processing device representing intended movement of the camera in each axis.

In any of the arrangements referred to above the means for determining actual movement of the camera/mounting may comprise an electronic gyroscope disposed on the camera or the camera mounting.

Also in any of the arrangements referred to above means may be provided for recording the image data and the signals from said first and second means for subsequent reproduction and means are provided for replaying the data and signal and for processing the replayed data/signal to produce a corrected image signal.

In the latter arrangement means may be provided for synchronising the electronic image data and the signals from the first and second means for determining intended and actual movement of the mounting/camera prior to recordal of the signals/data.

The following is a description of some specific embodiments of the invention; reference being made to the accompanying drawings in which:

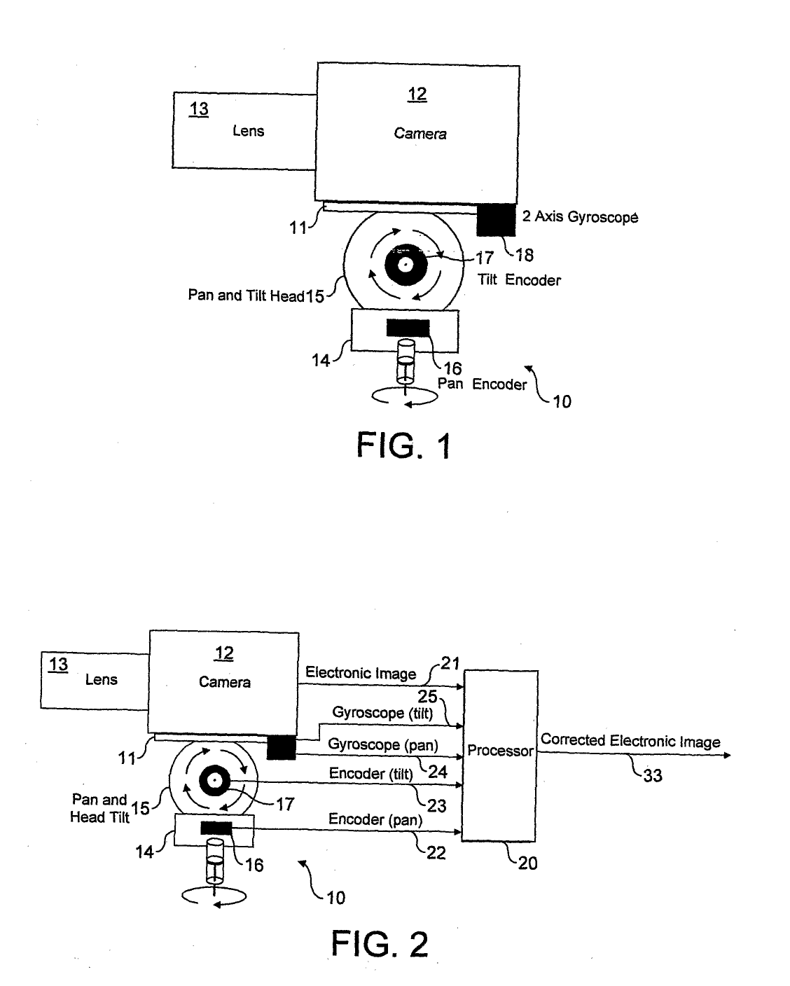

FIG. 1 is a diagrammatic side view of a TV/video camera supported on a mounting providing pan and tilt movement for the camera with encoders on the pan and tilt axes for monitoring intended movement of the camera as input by the operator and gyroscopes on the camera or support plate of the mounting for the camera for determining actual movement of the camera to enable unwanted movement to be determined for correction of the camera image;

FIG. 2 is a similar view to FIG. 1 in which electronic image signals from the camera are corrected immediately for unwanted movement in an external device;

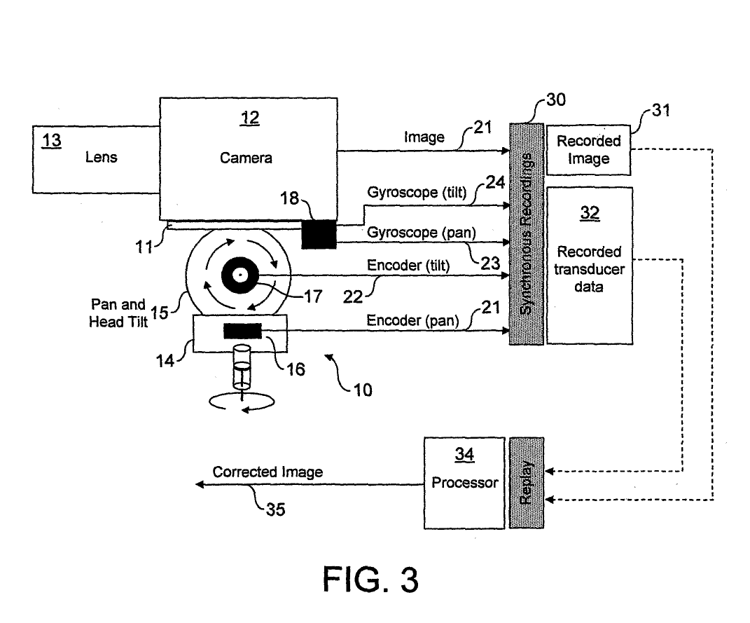

FIG. 3 is a similar view to FIG. 1 in which image signals from the camera are recorded synchronously with signals from the encoder and gyroscopes for subsequent offline image correction.

Referring firstly to FIG. 1 of the drawings, there is shown a pan and tilt mounting indicated generally at 10 for location on a tripod or pedestal (not shown) and having a mounting plate 11 on which a TV or video camera 12 is supported. The camera has a lens assembly indicated at 13 and has an internal CCD array on which the optical image is focused and converted into electronic data in a conventional manner.

The camera mounting 10 comprises a lower mounting 14 having relatively moveable parts which provide pan movement about a vertical axis for the camera and an upper mounting 15 having relatively moveable parts which provide tilt movement about a horizontal axis for the camera. The pan and tilt mountings embody rotary damping devices to aid the camera operator to move the camera as smoothly as possible to avoid any jerkiness in the image as transmitted/recorded by the camera. A balancing system for the camera/mounting in tilt movement so that the camera is fully counterbalanced in any position of tilt to which is it moved. Reference may be made to our UK Patent Nos. 2096345 (AVOCET), 2102757 (VISION 30), 2189042 (VISION 10), and Euro(UK) 0558597 (VECTOR BALANCE) which show various suitable forms of pan and tilt mountings for TV/video cameras to which the present invention is applicable.

The lower mounting 14 which permits movement in pan for the camera has an encoder 16 to determine the intended movement input to the camera by the camera operator and the upper part of the mounting 15 has an encoder 17 to determine tilt movement imparted to the camera by the operator. Actual movement of the camera is determined by 2-axis electronic gyroscope 18 mounted on the support plate 11 for the camera or on the camera itself to determine actual movement of the camera in the pan and tilt axes. The actual movement of the camera will include unwanted movements imparted to the camera from the ground on which the camera is supported or other external forces acting on the camera such as wind force. The differences between the actual movement as determined by the electronic gyroscope and the intended movements as determined by the encoders on the pan and tilt axes can be used to provide correction signals for correcting the position of the camera to eliminate unwanted movements. Our International Patent Publication No. PCT/GB99/04441 describes and illustrates ways in which the correction signals can be used to correct the camera for the unwanted movement so that it is eliminated from the scene as recorded by the camera.

The arrangement of the present invention corrects the image externally of the camera and FIG. 2 shows one such arrangement for doing so. A microprocessor 20 is located externally of the camera and the electronic data produced by the CCD array within the camera is connected to the processor by a line 21. The encoders 16 and 17 are connected by lines 22,23 to the processor and the electronic gyroscope is connected by lines 24,25 for pan and tilt movement to the processor. The microprocessor has software which computes signals corresponding to unwanted movement in the camera from the actual pan and tilt movements derived from the gyroscope and the intended movements derived from the encoders and corrects the electronic data for the image to eliminate the unwanted movement in the image data.

In a further arrangement shown in FIG. 3, the signals from the camera gyroscope and encoder are synchronised at an interface 30 and the image data is recorded in a device 31 and the encoder/gyroscope data is separately recorded in a device 32. The recorded data is held for subsequent replay when it is fed to a reply device 33 and thence to a microprocessor 34 where the image data is corrected for unwanted movement before transmitted at 35 for broadcasting.

1-6. (canceled)

7. A camera mounting system, comprising:
a camera having means to receive an optical image and to convert the optical image into an electronic image data;
a mounting for the camera comprising moving and non-moving components to provide for movement of the camera in at least one axis;
damping means for damping movement in the at least one axis of movement of the mounting; and
means for removing unwanted movement transmitted to the mounting comprising:
first means for measuring movement between the moving and non-moving parts of the mounting in the at least one axis to indicate intended camera movement;
second means for measuring actual movement of at least one of the camera and mounting in the at least one axis; and
an image processing device separate from the camera to receive the electronic image data and input from the first and second means for measuring movement of the camera, the image processing device determining the unwanted movement of the camera from intended and actual movement signals and modifying the image data to remove the unwanted camera movement from the data.

8. A camera mounting system as claimed in claim 7, wherein
the mounting is comprised of
parts relatively movable about a horizontal tilt axis for the camera;
parts which are relatively movable about a pan axis extending transversely to the tilt axis; and
rotary damping means acting between the relatively moveable parts in each axis;
the first means for measuring movement is configured to determine movements about the mounting part in both pan and tilt axes and provide corresponding signals to the image processing device; and
the second means for measuring movement is configured to provide signals corresponding to actual movement of at least one of the camera and mounting in the pan and tilt axes to the image processing device.

9. A camera mounting system as claimed in claim 7, wherein
encoders are configured between the relatively moving parts of the mounting in the at least one axis to provide a signal to the image processing device representing intended movement of the camera in each axis.

10. A camera mounting system as claimed in claim 7, wherein
the means for determining actual movement of at least one of the camera and mounting comprises an electronic gyroscope disposed on the camera or the camera mounting.

11. A camera mounting system as claimed in claim 7, wherein
means are provided for recording the electronic image data and the signals from the first and second means for measuring movement; and
means are provided for replaying the data and signals and for processing the replayed data and signals to produce a corrected image signal.

12. A camera mounting system as claimed in claim 11, wherein
means are provided for synchronizing the electronic image data and the signals from the first and second means for measuring movement prior to recording of the data and signals.
